(19) United States
(12) Patent Application Publication
(10) Pub. No.: US 2022/0285754 A1
(43) Pub. Date: Sep. 8, 2022

(54) METHOD FOR INTRODUCING A HEAT-CONDUCTING COMPOUND INTO A BATTERY MODULE AND INJECTION ARRANGEMENT

(71) Applicant: AUDI AG, Ingolstadt (DE)

(72) Inventors: Juergen GERBRAND, Kirchberg an der Murr (DE); Marc GORMANNS, Erlenbach (DE); Thomas MILDE, Wüstenrot (DE); Oliver SCHIELER, Gaimersheim (DE); Martin SCHUESSLER, Koesching (DE); Thomas WITTENSCHLAEGER, Ingolstadt (DE)

(73) Assignee: AUDI AG, Ingolstadt (DE)

(21) Appl. No.: 17/665,756

(22) Filed: Feb. 7, 2022

(30) Foreign Application Priority Data
Mar. 2, 2021 (DE) 102021104939.3

(51) Int. Cl. H01M 10/655; H01M 10/647; H01M 10/04

(52) U.S. Cl. CPC H01M 10/655; H01M 10/647; H01M 10/04

(57) ABSTRACT

A method for introducing a first heat-conducting compound into at least one first free space in a battery module, which is provided with a module housing and a cell pack arranged therein, and has a first housing side and an opposite second housing side, wherein the cell pack has a first side which faces toward the first housing side and a second side which faces toward the second housing side. The first free space is between the first side of the cell pack and the first housing side and a second free space is between the second side and the second housing side. Furthermore, a second heat-conducting compound is filled into the second free space overlapping in time with the filling of the first heat-conducting compound into the first free space.

### FIELD

The invention relates to a method for introducing a heat-conducting compound into at least one first free space in a battery module, wherein the battery module is provided with a module housing and a cell pack arranged in the module housing having at least one battery cell, wherein the module housing has a first housing side and a second housing side opposite to the first housing side, wherein the cell pack has a first side, which faces toward the first housing side, and a second side, which is opposite to the first side and faces toward the second housing side, and wherein the cell pack is arranged in the housing such that the first free space is between the first side of the cell pack and the first housing side and a second free space is between the second side and the second housing side. Furthermore, the heat-conducting compound is filled into the first free space. Furthermore, the invention also relates to an injection arrangement.

### BACKGROUND

Battery housings for accommodating one or more battery modules, in particular for high-voltage batteries, are known from the prior art. A cooling device is often arranged underneath the housing base in order to be able to dissipate heat from a battery module via the housing base to the cooling device. In principle, such a cooling device can also be arranged on any other sides of a battery module. In order to improve the thermal connection to such a cooling device, using a heat-conducting compound, also known as a gap filler, is also known, which can be introduced into such gaps, for example between a module housing and the cooling base. Various options are also available for introducing such a heat-conducting compound. For example, such a compound can be applied to the cooling base and then the battery module can be placed thereon. A similar procedure is described in DE 10 2018 222 459 A1, for example. Since such a gap filler is a very viscous compound, very high forces act on such a battery module and also on the cooling base when the module is pressed on, which requires additional measures, for example counterholders to support the cooling base. A gentler variant consists of injecting such a heat-conducting compound through a corresponding access opening into the gap between the battery module already placed on the base or inserted into the housing and the base itself, as is described, for example, in DE 10 2019 208 806 B3. Such an injection process is far more gentle for the battery modules.

Furthermore, as described for example in EP 3 444 889 A1, injecting a thermally conductive adhesive into a battery module itself in order to improve the thermal connection between the battery cells accommodated in such a module or the module housing and the housing is known from the prior art. Here, an attempt is made to reduce the load on the battery cells resulting from the injection pressure, for example by simultaneously injecting such a thermally conductive adhesive through multiple injection holes provided on the lower housing side or by aligning the module vertically during the injection and injecting the injection compound at an upper edge, so that it is additionally distributed under the influence of gravity.

This pressure acting on the battery cell is problematic, especially when the battery cells are pouch cells, for example, since their housings are typically formed from two thin films connected to one another at one edge, wherein such an edge can accordingly have a circumferential folded seam or flanging or a fold region, i.e., in general a connection region which protrudes outward. The effect of an injection pressure on one side of the battery cell can accordingly result in a very high local pressure load on the other side of this cell, because of this protruding edge, which is correspondingly pressed against the opposite housing inner side. This in turn can result in damage to the battery cells. The above-described measures for pressure reduction are only of limited help here. The effort to be able to fill such a thermal conduction compound even more gently into a battery module accordingly still continues.

### SUMMARY

It is therefore the object of the present invention to provide a method and an injection arrangement which make it possible to fill a heat-conducting compound into a battery module in a way which is as gentle as possible for at least one battery cell of the battery module.

In a method according to the invention for introducing a first heat-conducting compound into at least one first free space in a battery module, the battery module is provided with a module housing and a cell pack arranged in the module housing having at least one battery cell, wherein the module housing has a first housing side and a second housing side opposite to the first housing side. Furthermore, the cell pack has a first side, which faces toward the first housing side, and a second side, which is arranged opposite to the first side of the cell pack and faces toward the second housing side. Furthermore, the cell pack is arranged in the housing such that the first free space is between the first side of the cell pack and the first housing side and a second free space is between the second side of the cell pack and the second housing side. In addition, the first heat-conducting compound is filled into the first free space. In this case, a second heat-conducting compound is filled into the second free space overlapping in time with the filling of the first heat-conducting compound into the first free space.

It is thus advantageously possible for the heat-conducting compound to be simultaneously filled, at least temporarily, on opposite sides of the cell pack. The battery cells of the cell pack can thus advantageously be kept in equilibrium mechanically, i.e., in terms of force. In other words, due to the filling of the first heat-conducting compound into the first free space, a force is exerted on the at least one battery cell of the cell pack which is counteracted by an opposing force induced by the chronologically overlapping filling of the second heat-conducting compound into the second free space. Since the heat-conducting compound is a relatively viscous compound, in particular both in the case of the first and also the second heat-conducting compound, the forces acting on the cell pack, which are still present, can be distributed significantly more uniformly and accordingly no longer act locally on the battery cells. This greatly reduces the probability of damage to a battery cell. This is particularly advantageous especially for pouch cells as battery cells, but nonetheless the method described can also be used with other battery cells, for example prismatic or round cells, and also enables free spaces to be filled more gently with a heat-conducting compound.

The heat-conducting compound can be the gap filler mentioned at the outset. Such a heat-conducting compound can have a viscous and/or pasty consistency. It therefore has a higher viscosity than water, for example. Furthermore, the first and second heat-conducting compound can preferably represent the same heat-conducting compound.

The at least one battery cell of the cell pack can be designed, for example, as a lithium-ion cell. In addition, it can have any shape. Furthermore, the battery cell can have two cell pole taps, which are preferably not provided on the first and second side of the cell pack. In other words, the poles of the battery cell are preferably not to be embedded by the heat-conducting compound.

In addition, the first and second housing side of the module housing can define, for example, an upper and lower side of the battery module. In principle, however, the first and second housing side can be any desired module side, provided these two module sides are opposite to one another. The same applies to the two sides of the cell pack, which can also be referred to as a cell stack. For better illustration, however, the first and second side of the cell pack and also the first and second side of the module housing, i.e., the first and the second housing side, are sometimes also referred to as the upper and lower side hereinafter. The dimension of the battery module in a first direction from the upper side to the lower side will define, for example, a height of the battery module. Furthermore, it is preferred that the cell pack comprises multiple battery cells. These can then be arranged adjacent to one another, for example perpendicular to the first direction. The direction in which these multiple battery cells are arranged can define a longitudinal extension direction of the battery module, for example. The multiple battery cells of the cell pack are preferably clamped together. In addition, the cell pack can be arranged clamped inside the module housing, in particular clamped via housing sides different from the first and second housing sides, such that the cell pack is held inside the module housing by this clamping force such that its first side has the first free space toward the first housing side and in particular also has a distance to the first housing side, and its second side simultaneously has the second free space toward the second housing side, and in particular can also have a distance to the second housing side. Furthermore, the first and second side of the cell pack do not necessarily have to extend flatly in a direction perpendicular to the first direction. On the contrary, precisely when the battery cells are designed as pouch cells, for example, a surface structure results on the first side of the cell pack that is distinguished by the protruding flanged and folded connections described at the outset. Under certain circumstances, parts of these protruding flanged and folded connections can touch the first and/or second housing side. Therefore, the height of the cell pack, viewed in the first direction, does not necessarily have to be constant in a second direction perpendicular to the first.

In a very advantageous embodiment of the invention, when the battery module is provided, the cell pack is provided with at least one pouch cell, preferably multiple pouch cells, as the at least one battery cell. As already described, there are particularly great advantages of the invention especially in the case of pouch cells, since pouch cells are particularly susceptible to damage in conventional injection processes due to their uneven edge geometry. Especially for pouch cells, the invention can provide a particularly gentle heat-conducting compound injection. Pouch cells can thus be thermally connected to the inner sides of the module housing in a particularly gentle manner.

In a further advantageous embodiment of the invention, the first free space has multiple first partial regions which are arranged adjacent to one another perpendicularly to a first direction, and the second free space has multiple second partial regions which are arranged adjacent to one another perpendicularly to the first direction, wherein a respective first partial region is assigned to a second partial return and is arranged above the assigned one of the second partial regions in the first direction, wherein the first and second heat-conducting compound are filled in corresponding to one another such that a respective one of the first partial regions is filled with the first heat-conducting compound chronologically overlapping with filling of the second heat-conducting compound into the assigned second partial region. The first direction can in particular correspond to the above-defined first direction. This embodiment of the invention has the great advantage that particularly uniform filling of the heat-conducting compounds on both sides of the cell pack may be achieved in this way. As a result, opposite sides and in particular also partial regions of these opposite sides of the cell pack are almost always in a force equilibrium due to these correspondingly filled heat-conducting compounds. No local pressure points thus arise and possible damage to the battery cells can be efficiently counteracted. Such homogeneous filling can take place not only in the above-defined second direction, but also, for example, in a third direction, which is perpendicular to the first and second direction.

In the case of pouch cells in particular, which do not have a defined edge geometry, it is often the case that the first and second free spaces also differ from one another with respect to their geometry and their volume. Accordingly, such filling of the heat-conducting compound as uniformly as possible on both sides of the cell pack cannot be achieved simply by setting the same volume flow or filling pressure for the heat-conducting compound on both sides of the cell pack.

Accordingly, it represents a further, very advantageous embodiment of the invention if a current filling status of the first and second free space is detected during the filling of the first and second thermal conducting compound and the filling of the first and/or second thermal conducting compound is controlled in dependence on the respective current filling statuses. Uniform filling of the heat-conducting compound on both sides of the cell pack can thus advantageously be achieved. The filling of the heat-conducting compounds into the first and second free space takes place in accordance with a regulation in dependence on the current filling status of the respective free spaces. If, for example, on the first side of the cell pack, the heat-conducting compound has spread less strongly with respect to the already filled area of the first side than the heat-conducting compound on the second side of the cell pack, the volume flow at which the filling of the first heat-conducting compound takes place can accordingly thus be increased, for example, and vice versa. The filling can also be controlled or regulated such that ultimately the filling pressure times the area wetted by the heat-conducting compound is approximately equal at all times for both sides of the cell pack.

It is particularly advantageous if a quantity of first or second heat-conducting compound filled into the first and/or second free space per unit of time is controlled as a function of a determined difference between the current filling status of the first free space and the current filling status of the second free space. Such a control or regulation can take place as already described above. For example, an optical detection device can be used to detect the filling status. For example, multiple inspection openings can be provided in the first and second housing side, which, for example, can simultaneously function as ventilation openings, from which air can escape during the filling of the heat-conducting compound. A laser beam, for example, can be projected through these holes or inspection openings, which can accordingly detect whether the heat-conducting compound spreading in the respective free spaces has already reached these openings, which are preferably distributed accordingly over the respective housing sides. Accordingly, it can be detected how high the fill level of the heat-conducting compound is at the respective different positions of the first and/or second side of the cell pack and how far the corresponding heat-conducting compound fronts have spread on the respective sides of the cell pack. However, other detection options for detecting the current filling status are also conceivable.

Alternatively to such a regulation of the filling process, a control based on previously determined filling parameters can also take place. These can, for example, have been determined experimentally in advance and allow the filling process to take place in such a way that uniform filling can be achieved on both sides of the cell pack. Monitoring of the filling status can thus advantageously be dispensed with.

According to a further advantageous embodiment of the invention, the first heat-conducting compound is filled into the first free space through at least one first filling opening in the first housing side and the second heat-conducting compound is filled into the second free space through at least one second filling opening in the second housing side. For example, an injection device can approach such a filling opening and then inject the heat-conducting compound through the filling opening into the respective free space. In addition to the at least one filling opening, a respective housing side, i.e., the first and the second housing side, preferably also has a ventilation hole, so that the air displaced by the filled heat-conducting compound can escape. Multiple ventilation holes can also be provided at different positions, which ensures that the respective free spaces can be completely filled up, even if some of the ventilation openings are already covered by the spreading heat-conducting compound.

Furthermore, it is also particularly advantageous if not only multiple ventilation openings but also multiple filling openings are provided. It is therefore a further, very advantageous embodiment of the invention if the first heat-conducting compound is filled into the first free space through multiple first filling openings in the first housing side, at least overlapping in time, in particular simultaneously, and the second heat-conducting compound is filled into the second free space through multiple second filling openings in the second housing side at least overlapping in time, in particular simultaneously. By filling the thermal compound through several filling openings in the respective housing sides simultaneously, on the one hand, the gaps or free spaces can be filled faster and more uniformly and the local pressure on the battery cells can also be significantly reduced. In other words, by providing multiple filling openings, the filling pressure can be reduced, since the heat-conducting compound no longer has to be pressed into areas that are so far apart.

It is also advantageous if these filling openings are not arranged along a line on the same housing side. By providing multiple holes in the housing side that lie on the same line, a buckling line or predetermined breaking point is created, which reduces the stability of the housing. This can advantageously be prevented by filling openings that are arranged distributed at least in regions. It is already sufficient, for example, if the filling openings are arranged on a zigzag line or a serpentine line. In this case, multiple filling openings can be provided both in the second and in the third direction for the same housing side.

Furthermore, the invention also relates to an injection arrangement for introducing a heat-conducting compound into at least one first free space in a battery module, wherein the injection arrangement has a battery module having a module housing and a cell pack arranged in the module housing having at least one battery cell, wherein the module housing has a first housing side and a second housing side opposite to the first housing side, wherein the cell pack has a first side, which faces toward the first housing side, and a second side, which is opposite to the first side and faces toward the second housing side, wherein the cell pack is arranged in the housing such that the first free space is between the first side of the cell pack and the first housing side and a second free space is between the second side and the second housing side. Furthermore, the injection arrangement has an injection device which is designed to fill the first heat-conducting compound into the first free space. Furthermore, the injection device is designed to fill the first heat-conducting compound into the first free space and a second heat-conducting compound into the second free space overlapping in time. The filling preferably takes place simultaneously, that is to say it begins at the same point in time and ends at approximately the same point in time.

Accordingly, the advantages mentioned for the method according to the invention and its designs also apply in the same way here to the injection arrangement according to the invention.

Furthermore, it is preferred that the cell pack comprises multiple battery cells designed as pouch cells, which are arranged adjacent to one another in a second direction perpendicular to the first direction from the second housing side to the first housing side. Particularly great advantages of the invention are shown especially with respect to pouch cells, as has already been described.

It is furthermore particularly advantageous if the first and/or the second housing side has a groove structure having multiple grooves extending in parallel to one another in a third direction, wherein the third direction is perpendicular to the first and second direction.

This has the great advantage that the, for example wedge-shaped, connecting points or folded or flanged edges typically protruding in the edge region in pouch cells can be at least partially accommodated by the depressions provided by the grooves In other words, a geometric formation of the inner wall of the first and/or second housing side is thus provided which corresponds to the geometric formation of the surface structure of the first and/or second side of the cell pack. As a result, the volume of the free space to be filled, i.e., the first and/or second free space, is reduced. As a result, this free space also has a three-dimensional surface structure, both in the direction of the cell pack and in the direction of the relevant housing side. The housing itself is preferably made of metallic material, preferably aluminum. Metals, in particular aluminum, have a significantly higher thermal conductivity than the heat-conducting compound mentioned. In particular, the thermal conductivity of aluminum is approximately 50 times greater than that of typical gap fillers. Accordingly, it is particularly advantageous to keep the gap to be filled with the heat-conducting compound as small as possible. This can be achieved by the grooved design of the first and/or second housing side. This significantly improves the thermal connection to, for example, a heat sink that is to be coupled to the battery module.

The invention also includes refinements of the injection arrangement according to the invention, which have features as have already been described in conjunction with the refinements of the method according to the invention. For this reason, the corresponding refinements of the injection arrangement according to the invention are not described once again here.

The invention also comprises the combinations of the features of the described embodiments. The invention also comprises implementations that each have a combination of the features of several of the described embodiments, insofar as the embodiments were not described as mutually exclusive.

### BRIEF DESCRIPTION OF THE FIGURES

Exemplary embodiments of the invention are described hereinafter. In the figures:

FIG. 1 shows a schematic cross-sectional illustration of an injection arrangement having a battery module during a first time step of an injection process measured on the exemplary embodiment of the invention;

FIG. 2 shows a schematic illustration of the injection process at a later second time step according to one exemplary embodiment of the invention;

FIG. 3 shows a schematic illustration of the injection process at a later third time step according to one exemplary embodiment of the invention;

FIG. 4 shows a schematic illustration of a top view of an end face of a pouch cell in a module housing for an injection arrangement according to one exemplary embodiment of the invention; and

FIG. 5 shows a schematic illustration of a battery module for an injection arrangement according to one exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those shown. Furthermore, the described embodiments can also be supplemented by further ones of the above-described features of the invention.

In the figures, the same reference signs designate elements that have the same function.

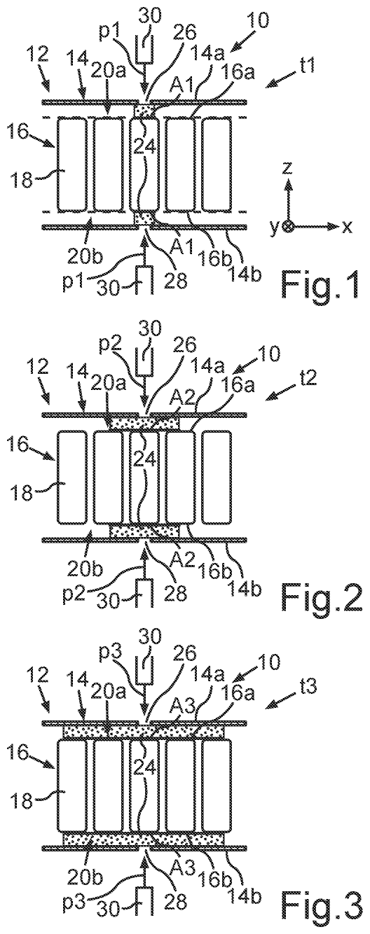

FIG. 1 shows a schematic illustration of an injection arrangement 10 having a battery module 12 during an injection process at a first time step t1 according to one exemplary embodiment of the invention. The battery module 12 has a module housing 14 in which a cell pack 16 is arranged. The cell pack 16 generally has at least one battery cell 18, preferably multiple battery cells, in this case five battery cells 18 as an example. These are preferably designed as pouch cells 18. Furthermore, the battery cells 18 of the cell pack 16 are arranged adjacent to one another in the x direction shown here. Further elements, for example, insulating layers, swelling plates or swelling pads, tensioning elements, or the like can be arranged between the cells 18 and also outside of the cell pack 16, but these are not shown here and are also not relevant to the invention. The module housing 14 has a first side 14a and a second side 14b opposite to the first side 14a. The cell pack 16 also has a first side 16a, which faces toward the first housing side 14a, and a second side 16b which is opposite to the first side 16a and faces toward the second housing side 14b. In the present case, the first housing side 14a represents an upper side of the housing 14 and the second housing side 14b represents a lower side of the housing 14. Correspondingly, the first side 16a of the cell pack 16 represents an upper side of the cell pack 16, and the second side 16b of the cell pack 16 a lower side of the cell pack 16. Furthermore, the cell pack 16 is arranged on the housing 14, so that a first free space 20a is arranged between the first side 16a of the cell pack 16 and the first housing side 14a, and a second free space 20b between the second side 16b on the second housing side 14b.

In order to be able to thermally connect battery cells in a housing as well as possible to a cooling element arranged on the outside of the housing, for example a cooling plate or the like, it is advantageous to fill free spaces, such as the two free spaces 20a, 20b described above, using a gap filler or a heat-conducting compound. This can be carried out by injecting such a heat-conducting compound. In conventional injection methods, the injection process and the viscosity of the material result in a corresponding pressure, which acts on the cells. This pressure and the force usually act on one side on the cells or on the cell packs or cell stacks, which are referred to here as cell packs, so that ultimately relatively high forces arise whose counterforce cannot be generated due to the lack of engagement points on the cell. In fact, gap filler injection or gap filler compression currently creates a buoyancy in the cells that cannot be counteracted. Especially with pouch cells, this can result in cell damage due to their geometry.

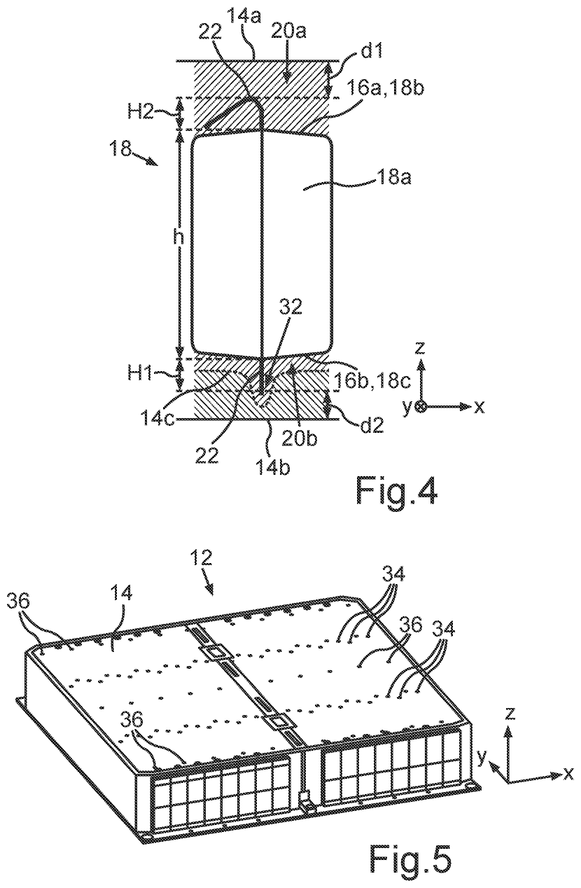

Such a pouch cell 18, if it is also preferably to be used as a battery cell 18 within the scope of the invention, is shown in FIG. 4, for example. FIG. 4 shows a schematic top view of an end face 18a of such a pouch cell 18. The illustration can, for example, correspond to a top view of the y axis, as is also shown in FIG. 1, for example. The upper side 18b of such a cell 18 defines a region of the upper side 16a of the cell pack 16. Correspondingly, a lower side 18c of the cell 18 also defines a part of the lower side 16b of the cell pack 16. Pouch cells have partially bulky connecting points 22, typically protruding in the edge region, which can represent, for example, folded or flanged edges. Accordingly, this results in an uneven geometry of the first and second side 16a, 16b of the cell pack 16. If pressure is now exerted on such a cell 18 from one side, its opposite side would be pressed with the connecting point 22 against the corresponding housing wall, which would cause local pressurization and could result in damage to the cell. The probability of such damage can advantageously be at least reduced, if not completely eliminated, by the invention. This will now be explained in more detail with reference to FIGS. 1 to 3. This can advantageously be accomplished by introducing the heat-conducting compound 24 as uniformly as possible on both sides 16a, 16b of the cell pack 16. In other words, the heat-conducting compound 24 is introduced on both sides simultaneously or at least overlapping in time. As a result, the cells 18 can be kept mechanically in equilibrium and, above all, no local forces act. Rather, the filled gap filler compound 24 achieves a uniform force distribution on the wetting surfaces of the cells 18, as a result of which the local pressure on the cells 18 is minimized. FIG. 1 shows the injection process, as already described, at a first time step t1, FIG. 2 at a later second time step t2, and FIG. 3 at an even later time step t3. In this case, the injection takes place through at least one injection opening 26 of a first housing side 14a and through at least one housing opening 28 in the second housing side 14b. Furthermore, an injection device 30 can be used for the injection, which approaches the respective openings 26, 28 on both sides and can be designed, for example, in the form of a nozzle or syringe and injects the heat-conducting compound 24 under a settable filling pressure. In the present example, the heat-conducting compound 24 is injected in the first time step t1 at a first filling pressure p1, in the second time step t2 at a second filling pressure p2, and in the third time step t3 at a third filling pressure p3. Furthermore, in the first time step t1, the area of the cell pack 16 wetted by the heat-conducting compound 24 is denoted by A1, in the second time step t2 by A2, and in the third time step t3 by A3. Although here, for example, for the first separating cut t1, both the filling pressure p1 and the area A1 are designated the same, this does not necessarily have to be the case for the upper and lower side. In particular, ideally at least the product of filling pressure and area should be equal for the upper and lower side 16a, 16b. In other words, the following is to apply:

p(O)·A(O)=p(U)·A(U).

p denotes the filling pressure and A denotes the area of the relevant cell pack side 16a or 16b wetted by the heat-conducting compound 24. O stands for the upper side 16a and U for the lower side 16b of the cell pack. This equality is to apply at least approximately for a respective time step of the injection process in order to achieve the most ideal force distribution possible on the battery cells 16. In order to ensure this, this can be carried out by an injection based on injection parameters experimentally determined in advance or in the form of a regulation. In the latter case, it is advantageous, for example, to monitor the filling status on the respective side and to carry out this regulation, for example of the injection pressure or the volume flow, as a function of a difference between the two sides 16a, 16b.

As already described, FIG. 4 shows a pouch cell 18. This can typically have a cell thickness of, for example, 15.6 mm in the y direction and, for example, a height h in the z direction of between 100 and 101 mm. The protruding connecting points 22 can initially remain unconsidered. These each have a height in the range between 2 and 3 mm. In this example, the connecting point 22 on the lower side 18c has a height H1 of 3 mm and the connecting point 22 on the opposite side 18b has a height H2 of 2 mm. The distance between the highest point of the connecting point 22 on the upper side 18b to the first housing side 14a can be, for example, 1 to 2 mm and is denoted by d1 here, while the corresponding dimension on the lower side 18c is denoted by d2 and, for example, can be only 0.7 mm. In order to fill these first and second free spaces 20a, 20b using the heat-conducting compound 24, a relatively large amount of such a heat-conducting compound 24 would be required without further measures. In order to reduce the free space 20a, 20b to be filled, the inside of the first and/or second housing side 14a, 14b can, for example, be designed having a geometry that corresponds to the battery cells 18, for example having a type of groove structure, as shown in FIG. 4 for the lower side 14b. This lower side, which is designed having a groove structure, is denoted in particular by 14c. Only a single groove 32 is illustrated here, which corresponds in terms of its geometry to the connecting point 22 on the lower side 18c of the cell 18.

The upper side, that is to say the first housing side 14a, can also be designed having a corresponding geometry in order to be able to advantageously reduce the required quantity of heat-conducting compound 24.

Furthermore, FIG. 5 shows a schematic and perspective illustration of a battery module 12 according to one exemplary embodiment of the invention. In particular, the first housing side 14a can be seen here from the outside. This has multiple filling openings 26 distributed over this first side 14a, only some of which are provided with a reference number for reasons of clarity. These preferably do not lie along the same line, so that no predetermined breaking point results. By providing multiple such filling openings 26, a gentler and faster filling of the heat-conducting compound 24 can be provided. In addition, the first housing side 14a also has ventilation openings 36, only some of which are provided with a reference number for reasons of clarity. The air displaced during the filling process can escape from these ventilation openings 36. The second housing side 14b can also be designed correspondingly, although it is not visible here. If the heat-conducting compound 24 is injected through these filling openings 26, this heat-conducting compound is distributed uniformly upward and downward into the various free spaces 20a, 20b. In the present example shown in FIG. 5, flow fronts form in and against the y direction, for example, starting from the filling openings 26, which at some point meet one another or arrive at the front and rear edge in relation to the y direction of the housing 14 shown. The ventilation holes 36 shown are accordingly located at the theoretical ends of the relevant flow fronts. This enables the respective free spaces 20a, 20b to be completely filled, since these ventilation openings 36 can be kept free of the gap filler compound for as long as possible.

Overall, the examples show how the invention can provide a gap filler injection on both sides, which enables particularly gentle introduction of a heat-conducting compound into a battery module, which prevents possible damage in particular in the case of pouch cells.

1. A method for introducing a first heat-conducting compound into at least one first free space in a battery module, comprising:
providing the battery module with a module housing and a cell pack arranged in the module housing and having at least one battery cell, wherein the module housing has a first housing side and a second housing side opposite to the first housing side, wherein the cell pack has a first side which faces toward the first housing side and a second side opposite to the first side, which faces toward the second housing side, wherein the cell pack is arranged in the housing in such a way that the first free space is between the first side of the cell pack and the first housing side and a second free space is between the second side and the second housing side; and
filling the first heat-conducting compound into the first free space;
wherein
a second heat-conducting compound is filled into the second free space overlapping in time with the filling of the first heat-conducting compound into the first free space.

2. The method as claimed in claim 1, wherein when the battery module is provided, the cell pack is provided with at least one pouch cell, preferably multiple pouch cells, as the at least one battery cell.

3. The method as claimed in claim 1, wherein the first free space has multiple first partial regions which are arranged adjacent to one another perpendicularly to a first direction, and the second free space has multiple second partial regions which are arranged adjacent to one another perpendicularly to the first direction, wherein a respective first partial region is assigned to a second partial region and is arranged above the assigned one of the second partial regions in the first direction, wherein the first and second heat-conducting compound are filled in corresponding to one another such that a respective one of the first partial regions is filled with the first heat-conducting compound overlapping in time with filling of the second heat-conducting compound into the assigned second partial region.

4. The method as claimed in claim 1, wherein a current filling status of the first and second free space is detected while the first and second heat-conducting compound is being filled in and the filling of the first and/or second heat-conducting compound is controlled as a function of the respective current filling states.

5. The method as claimed in claim 1, wherein a quantity of first or second heat-conducting compound filled into the first and/or second free space per unit of time is controlled as a function of a determined difference between the current filling status of the first free space and the current filling status of the second free space.

6. The method as claimed in claim 1, wherein the first heat-conducting compound is filled into the first free space through at least one first filling opening in the first housing side and the second heat-conducting compound is filled into the second free space through at least one second filling opening in the second housing side.

7. The method as claimed in claim 1, wherein the first heat-conducting compound is filled into the first free space through multiple first filling openings in the first housing side at least overlapping in time, in particular simultaneously, and the second heat-conducting compound is filled into the second free space through multiple second filling openings in the second housing side at least overlapping in time, in particular simultaneously.

8. An injection arrangement for introducing a first heat-conducting compound into at least one first free space in a battery module, comprising:
a battery module having a module housing and a cell pack arranged in the module housing and having at least one battery cell, wherein the module housing has a first housing side and a second housing side opposite to the first housing side, wherein the cell pack has a first side which faces toward the first housing side and a second side opposite to the first side, which faces toward the second housing side, wherein the cell pack is arranged in the housing in such a way that the first free space is between the first side of the cell pack and the first housing side and a second free space is between the second side and the second housing side;
an injection device which is designed to fill the first heat-conducting compound into the first free space;
wherein
the injection device is designed to fill the first heat-conducting compound into the first free space and a second heat-conducting compound into the second free space overlapping in time.

9. An injection arrangement as claimed in claim 8, wherein the cell pack comprises multiple battery cells designed as pouch cells, which are arranged adjacent to one another in a second direction perpendicular to a first direction from the second housing side to the first housing side.

10. The injection arrangement as claimed in claim 9, wherein the first and/or the second housing side has a groove structure having multiple grooves extending in parallel to one another in a third direction, wherein the third direction is perpendicular to the first and second direction.

11. The method as claimed in claim 2, wherein the first free space has multiple first partial regions which are arranged adjacent to one another perpendicularly to a first direction, and the second free space has multiple second partial regions which are arranged adjacent to one another perpendicularly to the first direction, wherein a respective first partial region is assigned to a second partial region and is arranged above the assigned one of the second partial regions in the first direction, wherein the first and second heat-conducting compound are filled in corresponding to one another such that a respective one of the first partial regions is filled with the first heat-conducting compound overlapping in time with filling of the second heat-conducting compound into the assigned second partial region.

12. The method as claimed in claim 2, wherein a current filling status of the first and second free space is detected while the first and second heat-conducting compound is being filled in and the filling of the first and/or second heat-conducting compound is controlled as a function of the respective current filling states.

13. The method as claimed in claim 3, wherein a current filling status of the first and second free space is detected while the first and second heat-conducting compound is being filled in and the filling of the first and/or second heat-conducting compound is controlled as a function of the respective current filling states.

14. The method as claimed in claim 2, wherein a quantity of first or second heat-conducting compound filled into the first and/or second free space per unit of time is controlled as a function of a determined difference between the current filling status of the first free space and the current filling status of the second free space.

15. The method as claimed in claim 3, wherein a quantity of first or second heat-conducting compound filled into the first and/or second free space per unit of time is controlled as a function of a determined difference between the current filling status of the first free space and the current filling status of the second free space.

16. The method as claimed in claim 4, wherein a quantity of first or second heat-conducting compound filled into the first and/or second free space per unit of time is controlled as a function of a determined difference between the current filling status of the first free space and the current filling status of the second free space.

17. The method as claimed in claim 2, wherein the first heat-conducting compound is filled into the first free space through at least one first filling opening in the first housing side and the second heat-conducting compound is filled into the second free space through at least one second filling opening in the second housing side.

18. The method as claimed in claim 3, wherein the first heat-conducting compound is filled into the first free space through at least one first filling opening in the first housing side and the second heat-conducting compound is filled into the second free space through at least one second filling opening in the second housing side.

19. The method as claimed in claim 4, wherein the first heat-conducting compound is filled into the first free space through at least one first filling opening in the first housing side and the second heat-conducting compound is filled into the second free space through at least one second filling opening in the second housing side.

20. The method as claimed in claim 5, wherein the first heat-conducting compound is filled into the first free space through at least one first filling opening in the first housing side and the second heat-conducting compound is filled into the second free space through at least one second filling opening in the second housing side.
